(19) United States
(12) Patent Application Publication
(10) Pub. No.: US 2026/0269354 A1
(43) Pub. Date: Sep. 10, 2026

(54) BATTERY MODULE, BATTERY PACK INCLUDING THE BATTERY MODULE, AND VEHICLE INCLUDING THE BATTERY MODULE

(71) Applicant: LG ENERGY SOLUTION, LTD., Seoul (KR)

(72) Inventors: So-Young KIM, Daejeon (KR); Soo-Youl KIM, Daejeon (KR)

(73) Assignee: LG ENERGY SOLUTION, LTD., Seoul (KR)

(21) Appl. No.: 19/558,142

(22) Filed: Mar. 5, 2026

(30) Foreign Application Priority Data
Mar. 6, 2025 (KR) 10-2025-0029164

(51) Int. Cl. H01M 10/613; H01M 10/6556; H01M 50/238; H01M 50/249; H01M 50/342

(52) U.S. Cl. CPC H01M 10/613; H01M 10/6556; H01M 50/238; H01M 50/249; H01M 50/3425; H01M 2200/10

(57) ABSTRACT

A battery module includes a module case that accommodates a plurality of battery cells therein and has a through-hole formed in one surface thereof, a cooling plate that is coupled to the surface of the module case and has a flow path in which a coolant is accommodated, the cooling plate being configured such that the coolant is discharged through the through-hole when a thermal event of the battery cells occurs, a sealing pad that is disposed between the module case and the cooling plate and seals at least a portion of a space between the module case and the cooling plate, and a coupler that couples the sealing pad and the module case such that the sealing pad comes into close contact with the module case.

### CROSS-REFERENCE TO RELATED APPLICATIONS

This application is based on and claims priority from Korean Patent Application No. 10-2025-0029164 filed on March 6, 2025, with the Korean Intellectual Property Office, the disclosure of which is incorporated herein in its entirety by reference.

### TECHNICAL FIELD

The present disclosure relates to a battery module, a battery pack including the battery module, and a vehicle including the battery module.

### BACKGROUND

As the demand for portable electronic products such as smartphones, tablet PCs, and smartwatches has increased significantly, and electric vehicles have become increasingly widespread, research on the batteries incorporated therein and secondary batteries capable of repeatedly charging and discharging, is actively conducted.

Commercialized secondary batteries in the present days include nickel cadmium batteries, nickel hydride batteries, nickel-zinc batteries, and lithium secondary batteries. Among the secondary batteries, the lithium secondary batteries have attracted significant attention due to their advantages over the nickel-based secondary batteries, such as little memory effect, which allows a flexible charging and discharging, a very low self-discharge rate, and a high energy density.

The lithium secondary batteries generally use lithium-based oxides and carbon materials as a positive electrode active material and a negative electrode active material, respectively. Such a lithium secondary battery includes an electrode assembly in which a positive electrode plate and a negative electrode plate, which are coated respectively with the positive electrode active material and the negative electrode active material, are arranged with a separator interposed therebetween, and an exterior material or a battery case, which hermetically accommodates the electrode assembly along with an electrolyte. In general, the lithium secondary batteries may be classified, according to the shape of the exterior material, into can-type secondary batteries in which the electrode assembly is accommodated in a metallic can, and pouch-type secondary batteries in which the electrode assembly is accommodated in a pouch formed of an aluminum laminate sheet.

Secondary batteries have been widely used for driving or energy storage in recent years not only in small-sized devices such as portable electronic devices but also in medium- to large-sized devices such as electric vehicles and energy storage systems (ESS). Such secondary batteries may be accommodated together in the interior of a module case in a state where a plurality of secondary batteries are electrically connected, thereby constituting a single battery module. In this case, each of the secondary batteries included in a single battery module may be referred to as a battery cell. Then, a plurality of such battery modules may be connected to constitute a single battery pack.

These battery modules have continuously raised safety concerns in the event of a thermal runaway, and this remains an issue yet to be addressed.

### SUMMARY

The present disclosure provides a battery module having an improved structure so as to maintain sealing between a cooling plate and a module case even when a thermal event occurs in the battery module, a battery pack including the battery module, and a vehicle including the battery module.

However, the technical issues of the present disclosure are not limited to those described above, and other issues not mentioned herein will be clearly understood by those skilled in the art from the following description of the present disclosure.

A battery module according to the present disclosure may include a module case that accommodates a plurality of battery cells therein and has a through-hole formed in one surface thereof; a cooling plate that is coupled to the one surface of the module case and has a flow path in which a coolant is accommodated, the cooling plate being configured such that the coolant is discharged through the through-hole when a thermal event of the battery cells occurs; a sealing pad that is disposed between the module case and the cooling plate and seals at least a portion of a space between the module case and the cooling plate; and a coupler couples the sealing pad and the module case such that the sealing pad comes into close contact with the module case.

According to the present disclosure, the coupler may have one end coupled to the sealing pad and a remaining end coupled to the module case.

The coupler may have higher rigidity than the sealing pad.

The coupler may extend from an edge of the sealing pad toward the module case.

A fastening groove may be provided in one of the module case and the coupler, and an engagement protrusion insertable into the fastening groove may be provided in a remaining one of the module case and the coupler.

The coupler may protrude from the sealing pad and be inserted into the module case, and may be configured to be caught by an inner surface of the module case.

The coupler may be inserted into the through-hole of the module case.

A coupling hole may be formed in the one surface of the module case, and the coupler may be inserted into the coupling hole.

A plurality of couplers may be provided and coupled to the module case.

A plurality of sealing holes in communication with the through-hole may be formed in the sealing pad along one direction, and the plurality of couplers may be disposed between the plurality of sealing holes.

The sealing pad may be configured to be compressible and recoverable, and the coupler may be configured to couple the sealing pad to the module case in a compressed state.

The sealing pad may include a thermally expandable material.

The thermally expandable material may be provided in a coated form on a surface that is in contact with the module case.

The cooling plate may include a fluid discharge hole that is in communication with the flow path and is disposed to face the through-hole, and a sealing member that is coupled to the cooling plate to block the fluid discharge hole and is ruptured when the thermal event occurs.

Further, the present disclosure provides a battery pack including at least one battery module according to the above-described embodiments.

Furthermore, the present disclosure provides a vehicle including at least one battery module according to the above-described embodiments.

According to the present disclosure, the sealing pad may be coupled in a state of being in close contact with the module case by the coupler. For example, the coupler mechanically couples the sealing pad and the module case, so that the sealing pad and the module case may stably maintain a close contact state even when a thermal runaway occurs. Accordingly, the coolant discharged from the cooling plate may smoothly flow into the battery module. Further, a high-temperature gas and particles discharged from the battery cells may be prevented or minimized from flowing into adjacent battery modules, thereby preventing propagation of a thermal runaway to surrounding battery modules.

Further, even when the sealing pad is pushed upward by a gas, the sealing pad is recovered by a corresponding gap, or a thermally expandable material expands, whereby a close contact state between the sealing pad and the battery module may be maintained. As a result, a time during which the coolant may flow into the interior of the module case through the through-hole may be secured, and stability of the battery module may be significantly improved.

In addition, the present disclosure may provide various other effects, and descriptions of effects that are described in respective embodiments or that may be readily inferred by those skilled in the art will be omitted.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a schematic perspective view of a battery module, according to an embodiment of the present disclosure.

FIG. 2 is an exploded perspective view of the battery module illustrated in FIG. 1.

FIG. 3 is a perspective view illustrating a state where a module case and a sealing pad of the battery module illustrated in FIG. 2 are coupled.

FIG. 4 is a cross-sectional view taken along line V-V' of FIG. 1.

FIG. 5 is a schematic cross-sectional view of a cooling plate illustrated in FIG. 3.

FIG. 6 is a perspective view of the sealing pad illustrated in FIG. 3.

FIG. 7 is a partial cross-sectional view illustrating a coupling structure of the module case and a coupler according to another embodiment of the present disclosure.

FIG. 8 is a schematic perspective view of the sealing pad and a coupler, according to another embodiment of the present disclosure as viewed from below.

FIG. 9 is a cross-sectional view illustrating a state where the sealing pad illustrated in FIG. 8 is coupled to the module case.

FIG. 10 is a schematic perspective view of the sealing pad and a coupler, according to another embodiment of the present disclosure as viewed from below.

FIG. 11 is a cross-sectional view illustrating a state where the sealing pad illustrated in FIG. 10 is coupled to the module case.

FIGS. 12A and 12B are cross-sectional views of a partial configuration of a battery module according to another embodiment of the present disclosure.

FIGS. 13A and 13B are cross-sectional views of a partial configuration of a battery module according to another embodiment of the present disclosure.

FIG. 14 is a diagram illustrating a battery pack, according to an embodiment of the present disclosure.

FIG. 15 is a diagram illustrating a vehicle, according to an embodiment of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described with reference to the attached drawings. Prior to this, the terms or words used in the specification and claims should not be construed as being limited to their ordinary or dictionary meanings, but should be construed as having meanings and concepts consistent with the technical spirit of the present disclosure, based on the principle that an inventor may appropriately define the concepts of terms in order to explain the inventor’s own invention in the best manner.

Accordingly, since the embodiments described in this description and the configurations illustrated in the drawings are merely example embodiments of the present disclosure, and do not represent all of the technical ideas of the present disclosure, it should be understood that at the time of filing, there may be various equivalents and modifications that could serve as alternatives to the embodiments.

In the descriptions herein, expressions indicating directions such as "up," "down," "left," "right," "front," and "rear" may be used. It is obvious to those skilled in the art that the expressions are used only to facilitate the description, and may vary depending on, for example, the location of a target object or an observer.

In the embodiments of the present disclosure, an X-axis direction illustrated in the drawings may refer to a left-right direction, a Y-axis direction may refer to a front-rear direction perpendicular to the X-axis direction on a horizontal plane (e.g., X-Y plane), and a Z-axis direction may refer to an up-down direction (e.g., vertical direction) perpendicular to both the X-axis direction and the Y-axis direction. Then, in the orthogonal coordinate system illustrated in the drawings, each axis has a positive (+) direction and a negative (-) direction, and directions indicated by X, Y, and Z in the drawings may refer to the positive (+) directions, while directions opposite thereto may refer to the negative (-) directions.

Further, in this specification, terms indicating directions, such as "inside" or "outside," may be used, and unless otherwise specified, “inside” may refer to a direction toward a central portion of a battery module, and “outside” may refer to a direction opposite thereto.

Further, this specification includes various embodiments, and descriptions of the same or similar portions in other embodiments are omitted, with emphasis placed on differences for each embodiment.

A battery module may be composed of a module case accommodating a plurality of battery cells and a cooling plate (e.g., heat sink) coupled to the upper side of the module case. Then, a sealing pad may be interposed between the module case and the cooling plate. In this case, the sealing pad may be coupled to an upper surface of the module case and a lower surface of the cooling plate by an adhesive. The sealing pad may seal a passage through which a coolant flows from the cooling plate to the interior of the module case when an event such as a thermal runaway occurs in the battery module.

In the battery module configured in this manner, when a thermal runaway occurs, a portion of the cooling plate may be ruptured by a gas discharged during the thermal runaway, and accordingly, the coolant flowing through the cooling plate may flow into the battery module, thereby extinguishing the thermal runaway.

In a conventional battery module, the adhesive strength of the adhesive may be reduced by the heat generated during the thermal runaway, and the cooling plate and the sealing pad coupled thereto may be pushed upward by a high-pressure gas discharged during the thermal runaway, so that an unwanted gap may be formed between the sealing pad and the battery module. For example, the coolant flowing from the cooling plate into the battery module may flow, along with the discharged gas, into the gap between the sealing pad and the battery module, and consequently, the coolant may not be smoothly supplied to the interior of the battery module or to an ignition point, thereby delaying extinguishment of the thermal runaway. Further, a high-temperature gas and particles flowing into adjacent battery modules through the gap may cause a thermal runaway in the adjacent battery modules. As a result, there is an issue in that a thermal runaway may propagate to an entire battery pack.

In consideration of the above, the present disclosure provides a battery module having an improved structure so as to maintain sealing between a cooling plate and a module case even when a thermal event occurs, a battery pack including the battery module, and a vehicle including the battery module.

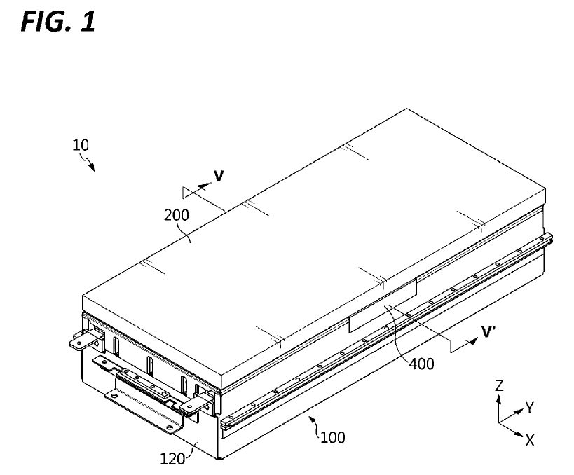

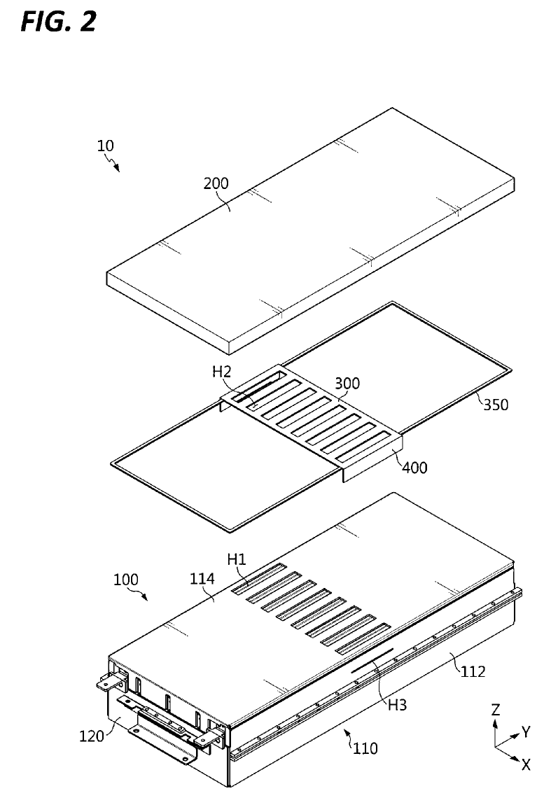

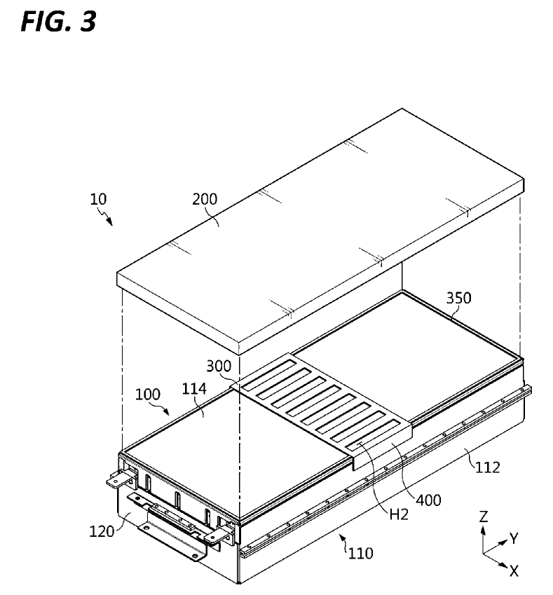

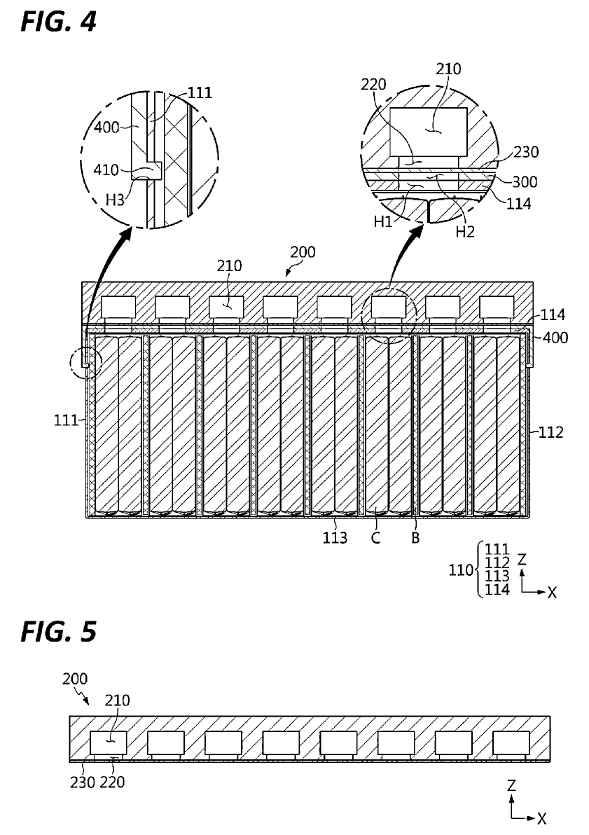

FIG. 1 is a schematic perspective view of a battery module according to an embodiment of the present disclosure, FIG. 2 is an exploded perspective view of the battery module illustrated in FIGS. 1, and 3 is a perspective view illustrating a state where a module case and a sealing pad of the battery module illustrated in FIG. 2 are coupled. Then, FIG. 4 is a cross-sectional view taken along the line V-V' of FIGS. 1, and 5 is a schematic cross-sectional view of a cooling plate illustrated in FIG. 3.

Referring to FIGS. 1 to 5, the battery module 10 according to the present embodiment may include a module case 100, a cooling plate 200, a sealing pad 300, and a coupler 400.

The module case 100 may be configured to accommodate a battery cell C in an empty space in the interior thereof. For example, as illustrated in FIGS. 2 and 4, the module case 100 may include a body frame 110 having a rectangular parallelepiped shape with both ends open, and end plates 120 covering both the ends of the body frame. In this case, the body frame 110 may be formed such that a left plate 111, a right plate 112, a bottom plate 113, and a top plate 114 are integrated with each other, and such a body frame 110 may be referred to as a mono frame. Alternatively, the body frame 110 may be formed such that the left plate 111, the right plate 112, and the bottom plate 113 are integrated with each other, and such a body frame may be referred to as a U-frame.

Then, a through-hole H1 may be provided in one surface of the module case 100. For example, as illustrated in FIG. 2, the through-hole H1 may be formed through the top plate 114, which is an upper surface of the module case 100.

The respective components of the module case 100, such as the body frame 110 and the end plates 120, may be mutually coupled by various methods, such as welding, insertion, adhesion, or hooks. Further, the module case 100 may be made of various materials such as a metal or plastic. Both the body frame 110 and the end plates 120 may be made of aluminum. In this case, mutual weldability is excellent, weight reduction is advantageous, and cooling performance may also be improved.

A plurality of battery cells C may be accommodated in the interior of the module case 100. Here, each battery cell C may refer to a secondary battery. The secondary battery may include an electrode assembly, an electrolyte, and a battery case. For example, the battery cell C may be a pouch-type secondary battery. As illustrated in FIG. 4, the plurality of battery cells C may be stacked side by side in a left-right direction (e.g., X-axis direction). In this case, each battery cell C may be disposed in an upright form in an up-down direction (e.g., Z-axis direction). Then, a blocking pad B may be disposed between the respective battery cells C to block the heat transfer between the battery cells.

The cooling plate 200 may be coupled to one surface of the module case 100. For example, as illustrated in FIG. 1, the cooling plate 200 may be coupled to the upper surface of the module case 100. A flow path 210 may be formed in the interior of the cooling plate 200. For example, as illustrated in FIG. 5, the cooling plate 200 may be formed in a flat plate shape, and the flow path 210 may be formed in the interior of the cooling plate. A coolant may be accommodated in the flow path 210. The coolant may circulate along the flow path 210, and to this end, the cooling plate 200 may be connected to an external coolant supply source.

When a thermal event occurs in the battery cells C, the coolant accommodated in the flow path 210 may be discharged through the through-hole H1 of the module case 100. For example, a portion of the cooling plate 200 may be configured to be ruptured when a thermal event occurs in the battery cells. Alternatively, a portion of the cooling plate 200 may be configured to be ruptured by a high-temperature and high-pressure gas discharged from the battery cells. Then, as the cooling plate 200 is ruptured, the coolant accommodated in the flow path 210 may be discharged through the through-hole H1 of the module case 100.

As the coolant, for example, cooling water may be used. The cooling water may circulate along the flow path 210 to cool the battery cells C. Alternatively, a fire-extinguishing liquid capable of extinguishing ignition of the battery cells may be used as the coolant. Such a fire-extinguishing liquid may cool the battery cells C during normal operation and when ignition of the battery cells C occurs, may efficiently extinguish the ignition.

The sealing pad 300 may serve to seal at least a portion of a space between the module case 100 and the cooling plate 200. The sealing pad 300 may be disposed between the module case 100 and the cooling plate 200. For example, the sealing pad 300 may be attached to the module case 100 using an adhesive. The sealing pad 300 may seal a portion of the space between the module case 100 and the cooling plate 200 in which the through-hole H1 of the module case 100 is positioned. As an example, the sealing pad 300 may have a structure surrounding the through-hole H1. Accordingly, the sealing pad 300 may seal a portion of the space between the module case 100 and the cooling plate 200 that faces the through-hole H1 or is directly connected to the through-hole H1.

The coupler 400 may serve to couple the sealing pad 300 and the module case 100. For example, the coupler may couple the sealing pad 300 and the module case 100 in a state of being in close contact with each other. The coupler may couple the sealing pad 300 and the module case 100 so as to maintain a close contact state therebetween even when a thermal event occurs in the battery cells C.

According to the embodiment with the above configuration, even when a thermal event occurs in the battery cells C or ignition of the battery cells occurs, a close contact state between the sealing pad 300 and the module case 100 may be maintained by the coupler 400. Accordingly, the entire coolant discharged from the cooling plate 200 may flow into the interior of the module case 100 through the space sealed by the sealing pad and the through-hole H1. For example, the coolant may flow into a space in which the battery cells C, in which the thermal event has occurred, are arranged, and ignition of the battery cells C may be extinguished by the coolant.

Further, in the present embodiment, diffusion of a gas and particles to adjacent battery modules through a gap between the sealing pad 300 and the battery module 100 may be prevented or minimized.

The coupler 400 may have one end coupled to the sealing pad 300 and the other end coupled to the module case 100. For example, as illustrated in FIG. 4, the coupler 400 may have both ends respectively coupled to the sealing pad 300 and the module case 100, thereby mechanically coupling the sealing pad 300 and the module case 100 between the two components.

According to the embodiment having the above configuration, coupling between the sealing pad 300 and the module case 100 may be more stably maintained by mechanical coupling formed by the coupler 400. For example, the sealing pad 300 and the module case 100 may be maintained in a coupled state by rigidity of the coupler 400. Unlike an adhesive bonding method using an adhesive that is sensitive to temperature changes, rigidity of the coupler 400 may be robustly maintained even at high temperatures, thereby enhancing reliability of the battery module.

After the occurrence of a thermal event, an inflow of the coolant may occur within a short time. Therefore, it may be important to maintain a close contact state between the sealing pad 300 and the module case 100 during this time, and this may enable the mechanical coupling by the coupler 400.

The coupler 400 may have greater rigidity than the sealing pad 300. In this regard, the sealing pad 300 may be configured to seal the space between the module case 100 and the cooling plate 200. Accordingly, the sealing pad 300 may be made of a material having relatively low rigidity so as to be in close contact between the module case 100 and the cooling plate 200. In the meantime, the coupler 400 may be configured to mechanically couple the sealing pad 300 and the module case 100 with its own rigidity. Accordingly, the coupler 400 may be configured to have greater rigidity than the sealing pad 300, thereby more firmly coupling the sealing pad 300 and the module case 100.

The sealing pad 300 and the coupler 400 may be made of different materials. For example, the sealing pad 300 and the coupler 400 may both be made of polymer compounds, but the coupler 400 may be made of a polymer compound having greater rigidity than that of the sealing pad 300.

Alternatively, the sealing pad 300 and the coupler 400 may be integrally formed, and then a post-treatment for reinforcing the strength of the coupler 400 may be performed. For example, an additional reinforcing member may be inserted into the coupler 400, or the coupler 400 may be additionally coated with a different material, for example, a polymer compound having higher strength (e.g., reinforced plastic).

As another method, the sealing pad 300 and the coupler 400 may be manufactured by an insert molding method. For example, a frame of the coupler 400 may first be made of a high-strength material, the frame of the coupler 400 may then be placed in a mold, and a molten polymer compound may be injected into the mold to manufacture the sealing pad 300 and the coupler 400. In this case, different materials may be applied to the sealing pad 300 and the coupler 400 using an insert molding process.

According to the embodiment having the above configuration, the sealing pad 300 and the module case 100 may be more firmly coupled by utilizing the high rigidity of the coupler 400.

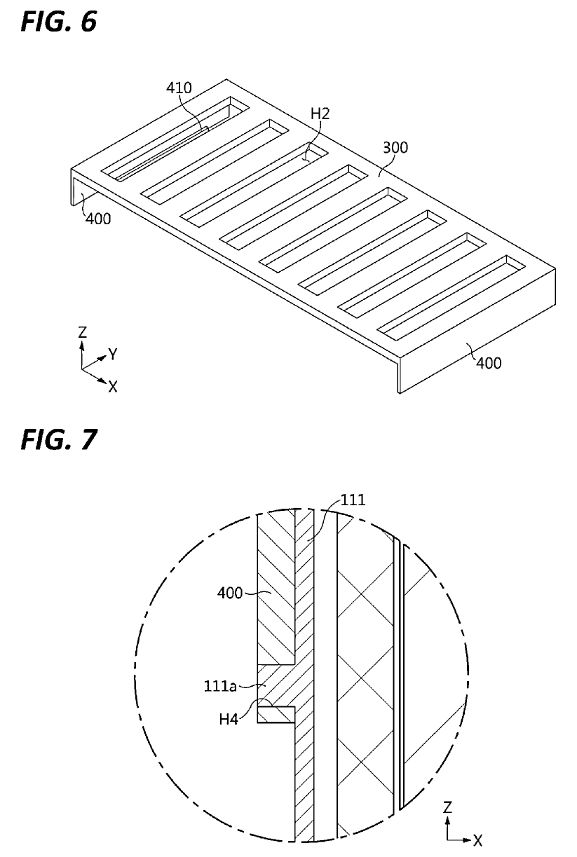

FIG. 6 is a perspective view of the sealing pad illustrated in FIG. 3.

Referring to FIG. 6, the coupler 400 according to the present embodiment may extend from an edge of the sealing pad 300. For example, one coupler 400 may be coupled to each of both edges of the sealing pad 300. Each coupler 400 may extend downward (in a -Z-axis direction) from the sealing pad 300 toward the module case 100 with reference to FIG. 6. Then, an upper end of each coupler 400 may be coupled to the sealing pad 300, and a lower end thereof may be coupled to the module case 100.

The coupler 400 and the sealing pad 300 may be integrally formed. Alternatively, the coupler 400 and the sealing pad 300 may be made of different materials, for example, by the above-described insert molding method.

According to the embodiment having the above configuration, both edges of the sealing pad 300 may be mechanically coupled to the module case 100 by the couplers 400. Accordingly, even when a thermal event occurs, a close contact state between the sealing pad 300 and the module case 100 may be maintained.

The module case 100 and the coupler 400 may be coupled to each other by an engagement structure. For example, a fastening groove H3 may be provided in one of the module case 100 and the coupler 400, and an engagement protrusion 410 may be provided in the other.

For example, as illustrated in FIGS. 2 and 4, the fastening groove H3 may be provided in side surfaces 111 and 112 of the module case 100. The fastening groove H3 may be formed in each of a left side surface 111 and a right side surface 112 of the module case 100. The fastening groove H3 may be elongated in a front-rear direction (e.g., Y-axis direction) of the module case 100 and may be formed to penetrate the side surface of the module case 100. Then, the engagement protrusion 410 may be provided at a lower end of the coupler 400. The engagement protrusion 410 may protrude from the lower end of the coupler 400 toward the module case 100. As illustrated in FIG. 4, the engagement protrusion 410 may be inserted into the fastening groove H3 of the module case 100, whereby the coupler 400 may be coupled to the module case 100.

According to the embodiment having the above configuration, the fastening groove H3, which is a position where the coupler 400 and the module case 100 are coupled, is exposed to the outside of the module case 100. Accordingly, an operator may easily couple the coupler 400 and the module case 100 while visually checking this position. Further, the above-described engagement structure facilitates not only a manufacturing process but also an engagement structure coupling process, thereby reducing a manufacturing time of the battery module.

In the meantime, as illustrated in FIG. 7, the engagement protrusion may be formed on the side surface of the module case. FIG. 7 is a partial cross-sectional view illustrating a coupling structure of the module case and a coupler according to another embodiment of the present disclosure. Referring to FIG. 7, an engagement protrusion 111a may protrude outward from the side surface 111 of the module case 100. A fastening groove H4 may be formed through a lower end of the coupler 400. When the engagement protrusion 111a is inserted into the fastening groove H4 of the coupler 400, the coupler 400 and the module case 100 may be mechanically coupled to each other.

The present embodiment may have an advantage in that the fastening groove H3 is not formed in the side surface of the module case 100. For example, even when an internal pressure increases due to the occurrence of a thermal event, a passage through which a gas may be discharged may be blocked, thereby reducing a risk that the engagement protrusion 111a is separated or disengaged from the fastening groove H4. Accordingly, a firm mechanical coupling state between the sealing pad 300 and the module case 100 may be stably maintained.

Further, by blocking a passage through which a high-temperature gas and particles may be discharged, heat transfer to adjacent battery modules may be effectively prevented or minimized, and mechanical rigidity of the module case may be preserved.

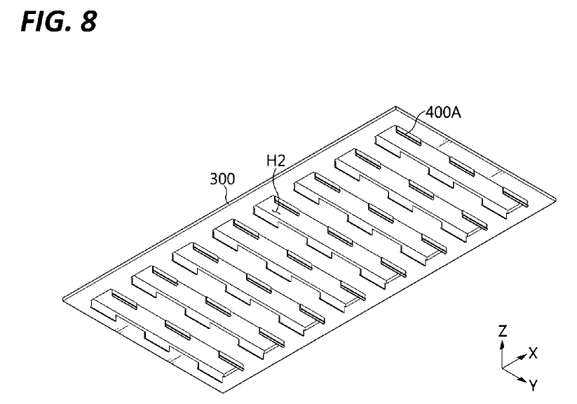

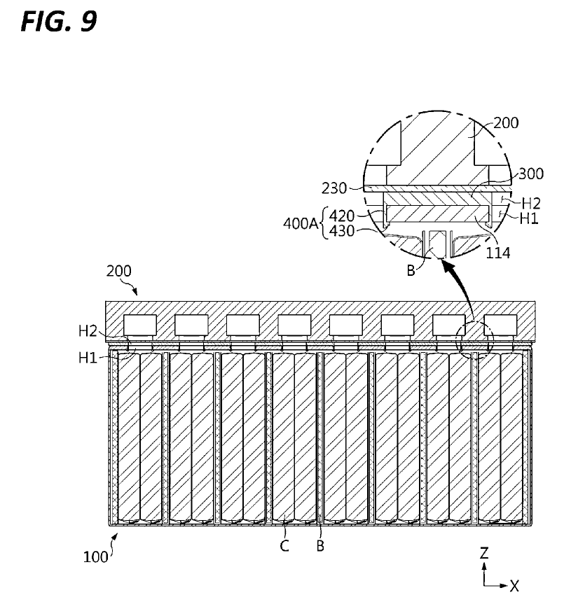

FIG. 8 is a schematic perspective view of the sealing pad and a coupler according to another embodiment of the present disclosure as viewed from below. FIG. 9 is a cross-sectional view illustrating a state where the sealing pad illustrated in FIG. 8 is coupled to the module case.

Referring to FIGS. 8 and 9, the coupler 400A according to the present embodiment may be configured to be caught by an inner surface of the module case 100. For example, the coupler 400A may protrude from the sealing pad 300 in one direction, or downward toward the module case 100. The coupler 400A may be inserted into the interior of the module case 100. The through-hole H1 may be formed in the upper surface of the module case 100, and the coupler 400A may be inserted into the interior of the module case 100 through the through-hole H1. Then, the inserted coupler 400A may be caught by the inner surface of the module case 100.

As an example, the coupler 400A may include a first part 420 and a second part 430. The first part 420 may extend downward from the sealing pad 300. The second part 430 may extend from an end of the first part 420 in a direction intersecting the first part 420, for example, in a horizontal direction. The first part 420 may be inserted into the interior of the module case 100, for example, through a hole formed in the upper surface of the module case 100. In this case, the coupler 400A may be inserted by a press-fitting method. Then, to facilitate the insertion of the coupler 400A, a tapered surface may be provided on one side of the second part 430. Then, after the coupler 400A is inserted, the second part 430 of the coupler 400 may be caught by the inner surface of the module case 100, for example, the top plate of the module case 100, thereby preventing or minimizing separation of the coupler 400A from the top plate 114 of the module case 100.

According to the embodiment having the above configuration, the sealing pad 300 and the module case 100 may be mechanically coupled to each other by the coupler 400A. In addition, the coupler 400A may be directly connected to the top plate 114 of the module case 100, thereby allowing the sealing pad 300 to come into close contact with the module case 100 more stably.

The coupler 400A may be inserted into the through-hole H1 of the module case 100. For example, as illustrated in FIG. 9, the coupler 400A may be coupled to the sealing pad 300 at a position corresponding to the through-hole H1 of the module case 100. The coupler 400A may be inserted into the interior of the module case 100 through the through-hole H1, and in the inserted state, the second part 430 of the coupler 400A may be caught by an inner surface of the top plate 114 of the module case 100, for example, the rim of the through-hole H1, whereby the coupler 400A may be coupled to the top plate 114 of the module case 100.

According to the embodiment having the above configuration, the sealing pad 300 may be more firmly and stably coupled to the module case 100. For example, when a thermal event occurs in the battery cells C, the sealing pad 300 may receive an external force that tends to separate the sealing pad 300 from the module case 100 due to a gas discharged through the through-hole H1. Such an external force tending to separate the sealing pad 300 may be concentrated around the through-hole H1 of the module case 100, and thus, the sealing pad 300 may begin to separate from the module case 100 from this portion.

However, in the present embodiment, since the coupler 400A couples the module case 100 and the sealing pad 300 at the through-hole H1, separation of the sealing pad 300 from the module case 100 may be effectively prevented or minimized.

A plurality of couplers 400A may be provided. For example, as illustrated in FIG. 8, the plurality of couplers 400A may be spaced apart from each other in a left-right direction and in a front-rear direction. Then, the sealing pad 300 and the module case 100 may be coupled at a plurality of positions by the plurality of couplers 400A, so that the entire sealing pad 300 may be firmly and stably coupled to the module case 100.

As illustrated in FIG. 9, a plurality of through-holes H1 may be formed in the module case 100. The plurality of through-holes H1 may be spaced apart from each other along a left-right direction (e.g., X-axis direction), which is a direction in which the battery cells C are arranged. Then, a sealing hole H2 may be provided in the sealing pad 300. For example, as illustrated in FIG. 8, the sealing pad 300 may be formed in a plate shape. Then, the sealing hole H2 may be formed through the sealing pad 300. The sealing hole H2 may be positioned to face the through-hole H1 of the module case 100, such that the through-hole H1 and the sealing hole H2 may be in communication with each other. A plurality of sealing holes H2 may be provided, and the plurality of sealing holes H2 may be arranged along one direction. For example, the plurality of sealing holes H2 may be spaced apart from each other in a left-right direction (e.g., X-axis direction), such that each sealing hole H2 may be in communication with a corresponding one of the through-holes H1.

Then, the plurality of couplers 400A may be arranged between the plurality of sealing holes H2. For example, as illustrated in FIG. 8, six couplers 400A may be provided between each pair of adjacent sealing holes H2. In this case, three couplers 400A may be formed at a boundary ( e.g., the rim of the sealing hole) with the left sealing hole H2 such that the three couplers 400A may be spaced apart from each other in a front-back direction (e.g., Y-axis direction). Then, the remaining three couplers 400A may be provided at a boundary with the right sealing hole H2 such that the three couplers 400A may also be spaced apart from each other in a front-rear direction.

According to the embodiment having the above configuration, as illustrated in FIG. 9, the plurality of couplers 400A may be coupled for each through-hole H1 of the module case 100, and the sealing pad 300 may be firmly coupled to the top plate 114 of the module case 100 as a whole. Since the coupler 400A is fastened to the through-hole H1, which is a position where an external force to separate the sealing pad 300 tends to be concentrated, the sealing pad 300 may be more firmly coupled to the module case 100.

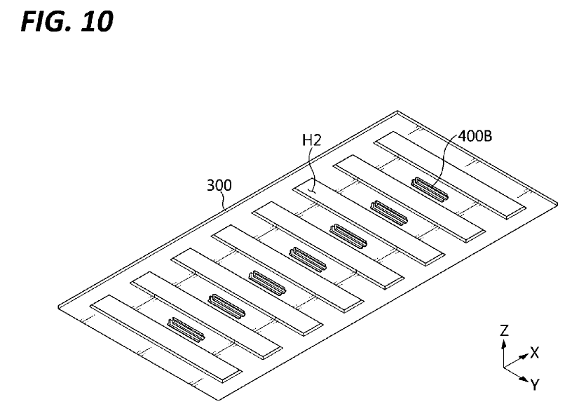

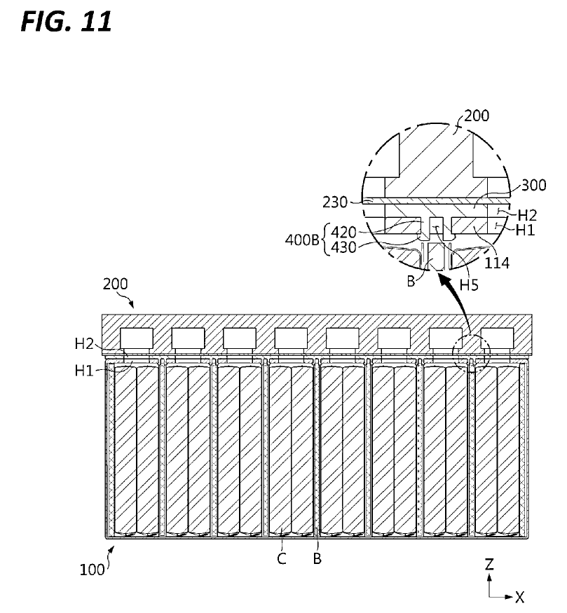

FIG. 10 is a perspective view of the sealing pad and a coupler according to another embodiment of the present disclosure as viewed from below. FIG. 11 is a cross-sectional view illustrating a state where the sealing pad illustrated in FIG. 10 is coupled to the module case.

Referring to FIGS. 10 and 11, the coupler 400B according to the present embodiment may be coupled to a coupling hole H5 of the module case 100. For example, as illustrated in an enlarged view in FIG. 11, the module case 100 may be provided with the coupling hole H5 formed therethrough. Alternatively, the coupling hole H5 may be formed through the top plate 114 of the module case 100. Then, the coupler 400B may include the first part 420 protruding downward from the lower surface of the sealing pad 300 and the second part 430 extending in a horizontal direction from an end of the first part 420. The coupler 400B is inserted into the coupling hole H5, and in the inserted state, the second part 430 of the coupler 400B is caught by the coupling hole H5, whereby the coupler 400B may be coupled to the module case 100.

According to the embodiment having the above configuration, the coupler 400B may be coupled to the coupling hole H5. In this case, the coupling hole H5 is provided only for coupling with the coupler 400B, and thus, the position and number thereof may be determined without being constrained by other components. Accordingly, it is easy to change the position and number of coupling holes H5, and the number and position of points where the sealing pad 300 and the module case 100 are coupled may be easily changed. For example, the sealing pad 300 and the module case 100 may be coupled at a central portion of the sealing pad 300, or at an edge portion of the sealing pad 300. Further, as illustrated in FIG. 11, the coupling hole H5 may be formed above a thermal insulation pad B disposed between the battery cells C. Then, by changing a coupling position between the sealing pad 300 and the module case 100, which corresponds to the position of the coupling hole H5, the battery module 10 may be designed (manufactured) such that the sealing pad 300 and the module case 100 are efficiently coupled.

Further, when the coupler 400A is coupled to the through-hole H1 as in the embodiment of FIG. 9 described above, there may be a possibility that the coupler 400A is separated from the through-hole H1 due to a high-temperature and high-pressure gas discharged concentrically through the through-hole H1, which may result in a release of the coupling between the sealing pad 300 and the module case 100 by the coupler 400A. In the present embodiment, little gas may be discharged through the coupling hole H5. When the coupling hole H5 is formed above the thermal insulation pad B rather than the battery cell C, a gas is hardly discharged through the coupling hole H5. Accordingly, it is possible to prevent or minimize an issue in that the coupling by the coupler 400A is released due to a discharged gas.

As illustrated in FIG. 10, the sealing pad 300 may be formed in a plate shape. A plurality of sealing holes H2 may be provided in the sealing pad 300, and each sealing hole H2 may be in communication with a corresponding one of the through-holes H1. The plurality of sealing holes H2 may be arranged along one direction. For example, the plurality of sealing holes H2 may be spaced apart from each other in a left-right direction, such that each sealing hole H2 may be in communication with the corresponding through-hole H1.

Then, a plurality of couplers 400B may be provided, and arranged between the sealing holes H2. For example, as illustrated in FIG. 10, two couplers 400B may be arranged as a pair between each pair of adjacent sealing holes H2. In this case, the second parts 430 of the paired couplers 400B may extend in opposite directions. As illustrated in an enlarged view in FIG. 11, among the two couplers 400B, the second part 430 of the coupler 400B on the left side may extend leftward, and the second part 430 of the coupler 400B on the right side may extend rightward. Accordingly, the couplers 400B may be configured to be caught by both edges of the coupling hole H5, respectively, in a state where the two couplers 400B are inserted into the connecting hole H5. Accordingly, the sealing pad 300 and the module case 100 may be more firmly coupled.

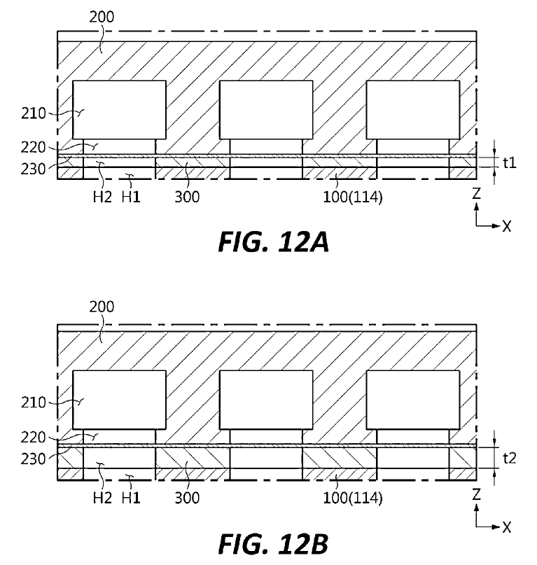

FIGS. 12A and 12B are cross-sectional views of a partial configuration of a battery module according to another embodiment of the present disclosure, illustrating a recovery structure of the sealing pad 300 that is coupled in a compressed state.

The present embodiment will be described with reference to FIGS. 12A and 12B and 4 together.

The sealing pad 300 according to the present embodiment may be configured to be compressible and recoverable.

Further, the sealing pad 300 may be made of a material having resilience. For example, the sealing pad 300 may be made of rubber or a polymer compound. As illustrated in FIGS. 12A and 12B, the sealing pad 300 may be compressed and recovered in a thickness direction (e.g., Z-axis direction) thereof. For example, the sealing pad 300 may have a thickness t1 as illustrated in FIG. 12A in a compressed state, and may have a thickness t2 as illustrated in FIG. 12B in a normal state (e.g., a recovered state).

Then, the coupler 400 may be configured to couple the sealing pad 300 in a compressed state to the module case 100. For example, as illustrated in FIG. 4, the coupler 400 may be provided at each of both edges of the sealing pad 300. Then, the coupler 400 couples the sealing pad 300 to the module case 100, and at this time, as illustrated in FIG. 12A, the sealing pad 300 may be coupled in a state compressed to the thickness t1. For example, the coupler 400 may be designed such that the coupling protrusion 410 of the coupler 400 is caught in the fastening groove H3 of the module case 100 in a state where the sealing pad 300 is compressed to the thickness t1.

When a thermal event occurs in a state where the sealing pad 300 is coupled as described above, the sealing pad 300 may be pushed upward (in a +Z-axis direction) by a gas. In the present disclosure, although the coupler 400 couples the sealing pad 300 to the module case 100, the sealing pad 300 may be pushed upward to some extent at a central portion thereof (e.g., a position distant from the coupler 400). Then, when the sealing pad 300 is pushed upward, as illustrated in FIG. 12B, the compressed sealing pad 300 may be recovered again to the original thickness t2 thereof. Accordingly, even if the sealing pad 300 is pushed upward by at least a recovered thickness (e.g., t2-t1), a close contact state between the sealing pad 300 and the module case 100 may be maintained.

According to the embodiment with the above configuration, a time during which the sealing pad 300 and the module case 100 remain in close contact at the initial stage of a thermal event may be extended to some extent, thereby securing a time during which the coolant may flow into the interior of the module case 100 through the through-hole H1. Accordingly, the stability of the battery module 10 may be improved.

Meanwhile, referring back to FIG. 2, the battery module 10 may further include a rim seal 350. The rim seal 350 may be formed in a rectangular ring shape corresponding to the module case 100. The rim seal 350 may be disposed between the module case 100 and the cooling plate 200. For example, the rim seal 350 may be bonded to the upper surface of the module case 100. The cooling plate 200 and the module case 100 may be coupled to each other by a resin interposed therebetween. In this case, the resin may have thermal conductivity. The rim seal 350 seals a space between the module case 100 and the cooling plate 200, thereby allowing the resin to solidify between the module case 100 and the cooling plate 200.

The rim seal 350 may be coupled to the sealing pad 300. For example, the rim seal 350 may be integrally formed with the sealing pad 300. Alternatively, the rim seal 350 and the sealing pad 300 may be manufactured separately and bonded to each other. In this case, the sealing pad 300 may be formed to have a thickness greater than that of the rim seal 350. For example, the sealing pad 300 may have the thickness t2 illustrated in FIG. 12B, and the rim seal 350 may have the thickness t1.

Then, in a state where the sealing pad 300 and the rim seal 350 are bonded to the upper surface of the module case 100, the sealing pad 300 may be compressed to the thickness t1 by the cooling plate 200, and by coupling the coupler 400 to the module case 100, the sealing pad 300 may be coupled in a compressed state to the module case 100.

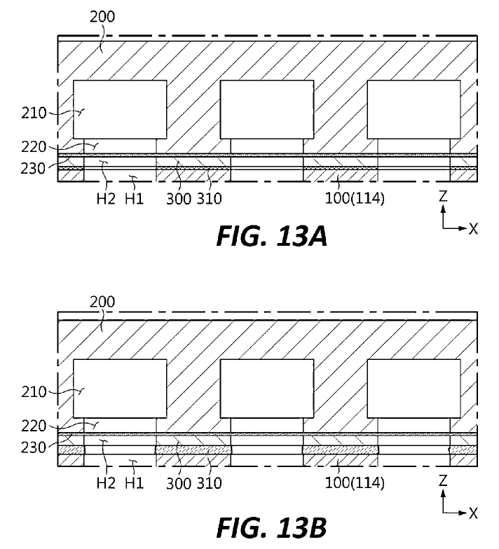

FIGS. 13A and 13B are cross-sectional views of a partial configuration of a battery module according to another embodiment of the present disclosure.

Referring to FIGS. 13A and 13B, the sealing pad 300 according to the present embodiment may include a thermally expandable material. The thermally expandable material is a material that expands in volume when heat is applied, and may be a polymer-based thermally expandable material. For example, the thermally expandable material may be applied to or coated on a surface of the sealing pad 300. Alternatively, as illustrated in FIG. 13A, a coating layer 310 made of the thermally expandable material may be provided on a lower surface of the sealing pad 300, which is a surface that comes into contact with the module case 100.

In a normal state of the battery module, the sealing pad 300 may be coupled in close contact with the upper surface of the module case 100, as illustrated in FIG. 13A. When a thermal event occurs, the sealing pad 300 may be pushed upward (in a +Z-axis direction) by a gas. At the same time, as illustrated in FIG. 13B, the coating layer 310, which is the thermally expandable material, is heated and expands, and accordingly, the expanded coating layer 310 may fill a gap formed as the sealing pad 300 is pushed upward. Accordingly, even if the sealing pad 300 is pushed upward, a close contact state between the coating layer 310 of the sealing pad 300 and the module case 100 may be maintained for a predetermined time.

According to the embodiment with the above configuration, a time during which the sealing pad 300 and the module case 100 remain in close contact at the initial stage of a thermal event may be extended to some extent, thereby securing a time during which the coolant may flow into the interior of the module case 100 through the through-hole H1. Accordingly, the stability of the battery module may be greatly improved.

Referring back to FIG. 5, the cooling plate 200 will be further described. The cooling plate 200 may include the flow path 210, a fluid discharge hole 220, and a sealing member 230. The flow path 210 may be formed in the interior of the cooling plate 200. For example, the cooling plate 200 may be formed in a rectangular plate shape, and the flow path 210 may be formed in the interior of the cooling plate. The coolant may be accommodated in the flow path 210, and may circulate along the flow path 210. The fluid discharge hole 220 may be formed to be in communication with the flow path 210. As illustrated in FIG. 4, in a state where the cooling plate 200 and the module case 100 are coupled to each other, the fluid discharge hole 220 may be positioned above the through-hole H1 so as to face the through-hole H1. A plurality of fluid discharge holes 220 may be formed, and arranged to face the respective through-holes H1. The sealing member 230 may be coupled to the cooling plate 200 so as to block the fluid discharge hole 220. For example, the sealing member 230 may have a film-shaped structure having a small thickness. The sealing member 230 may be coupled to the lower surface of the cooling plate 200, and accordingly, the fluid discharge hole 220 may be sealed by the sealing member 230. The sealing member 230 may be configured to be ruptured by a gas discharged from the battery cells C when a thermal event occurs.

Meanwhile, although not illustrated in the drawings, the battery module 10 may further include a busbar assembly. The busbar assembly may be configured for electrical connection of a plurality of battery cells C. For example, the busbar assembly may include a busbar terminal and a busbar housing. Here, the busbar terminal may be electrically connected to the battery cell C. The busbar terminal may be made of a conductive metal such as copper, and may be in direct contact with an electrode lead of the battery cell C. The busbar housing may be made of an electrically insulating material such as plastic, and may fix the position of the busbar terminal by allowing the busbar terminal to be mounted therein. To this end, the busbar housing may be provided with a space or structure in which the busbar terminal may be mounted.

As described above, according to the present disclosure, the sealing pad 300 may be coupled to the module case 100 in a close contact state by the coupler 400. Since the coupler 400 mechanically couples the sealing pad 300 and the module case 100, a stable close contact state between the sealing pad 300 and the module case 100 may be maintained even when a thermal runaway occurs. Accordingly, the coolant discharged from the cooling plate 200 may smoothly flow into the interior of the module case 100. Further, a high-temperature gas and particles discharged from the battery cell C may be prevented or minimized from flowing into adjacent battery modules. As a result, propagation of a thermal runaway phenomenon to surrounding battery modules may be blocked.

Furthermore, even when the sealing pad 300 is pushed upward by a discharged gas, the sealing pad 300 may be recovered by a corresponding gap, or the thermally expandable material 310 may expand, and accordingly, a close contact state between the sealing pad 300 and the module case 100 may be maintained. Thereby, a time during which the coolant may flow into the interior of the module case 100 through the through-hole H1 may be secured, and as a result, the stability of the battery module may be greatly improved.

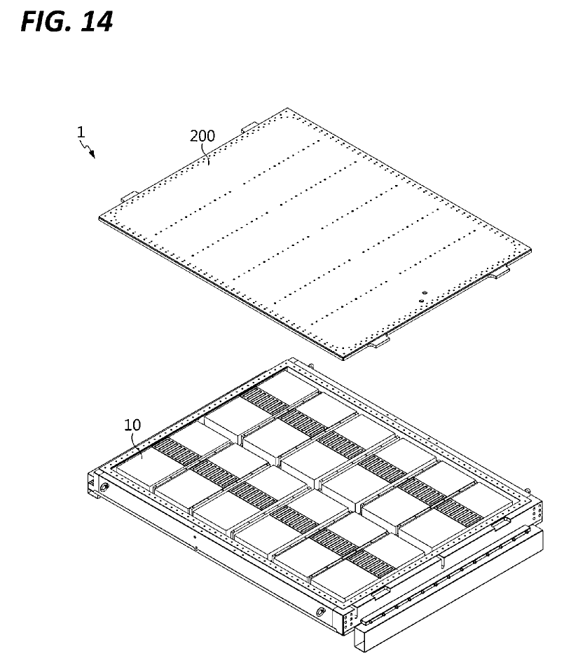

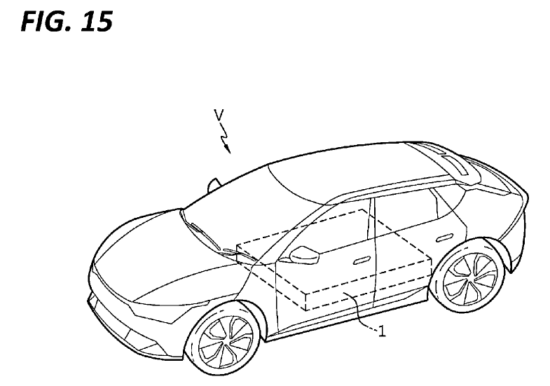

FIG. 14 is a diagram illustrating a battery pack according to an embodiment of the present disclosure, and FIG. 15 is a diagram illustrating a vehicle according to an embodiment of the present disclosure

Referring to FIG. 14, the battery pack 1 may include at least one battery module 10 according to the foregoing embodiment and a pack case accommodating the at least one battery module 10. In this case, the cooling plate 200 may be configured to cool a plurality of battery modules 10 at the same time. For example, instead of being separately coupled to each module case, a single cooling plate 200 may be manufactured in a large size so as to be coupled to a plurality of module cases at the same time.

The battery pack 1 may further include various battery pack components known at the time of filing of the present disclosure, such as a BMS, a busbar, a relay, and a current sensor.

Meanwhile, components such as the BMS, busbar, relay, and current sensor may also be included as components of the battery module 10 according to the present disclosure. In this case, components such as the BMS, busbar, relay, and current sensor may be provided in the interior of the module case 100. In this case, the battery module 10 may be referred to as a battery pack, and the module case 100 may be referred to as a pack case. Furthermore, in this case, the battery module 10 according to the present disclosure may be a cell-to-pack type battery pack in which the battery cells C are directly mounted in the pack case.

Referring to FIG. 15, the battery pack 1 may be provided in a vehicle V as a power source of the vehicle. For example, the battery pack 1 may be provided in the vehicle V such as an electric vehicle, a hybrid vehicle, or other types of vehicles that may use the battery pack 1 as a power source.

The battery pack 1 and the vehicle V according to the present embodiment include the battery module 10 according to the foregoing embodiment, and thus, may implement the battery pack 1 and the vehicle V having all the advantages of the battery module 10 according to the foregoing embodiment.

In addition, the battery pack 1 may also be applied not only to the vehicle V but also to other devices, apparatus, and facilities using secondary batteries, such as an energy storage system.

According to the various embodiments described above, it is possible to provide the battery module 10 capable of preventing damage to components mounted on an electronic circuit, as well as the battery pack 1 including the battery module 10, and the vehicle V including the battery module 10.

While embodiments of the present disclosure have been described with reference to the drawings, the present disclosure is not limited to the embodiments, and various modifications may be made by those skilled in the art of the present disclosure without departing from the technical gist of the present disclosure set forth in the claims. The modifications should not be interpreted independently from the technical idea or scope of the present disclosure.

What is claimed is:

1. A battery module comprising:
a module case configured to accommodate a plurality of battery cells therein and having a through-hole formed in one surface thereof;
a cooling plate coupled to the one surface of the module case and having a flow path in which a coolant is accommodated, the cooling plate being configured such that the coolant is discharged through the through-hole when a thermal event of the battery cells occurs;
a sealing pad disposed between the module case and the cooling plate and configured to seal at least a portion of a space between the module case and the cooling plate; and
a coupler configured to couple the sealing pad and the module case such that the sealing pad comes into close contact with the module case.

2. The battery module according to claim 1, wherein the coupler has one end coupled to the sealing pad and a remaining end coupled to the module case.

3. The battery module according to claim 2, wherein the coupler has higher rigidity than the sealing pad.

4. The battery module according to claim 1, wherein the coupler extends from an edge of the sealing pad toward the module case.

5. The battery module according to claim 4, wherein a fastening groove is provided in one of the module case and the coupler, and an engagement protrusion insertable into the fastening groove is provided in a remaining one of the module case and the coupler.

6. The battery module according to claim 1, wherein the coupler protrudes from the sealing pad and is inserted into the module case, and is configured to be caught by an inner surface of the module case.

7. The battery module according to claim 6, wherein the coupler is inserted into the through-hole of the module case.

8. The battery module according to claim 6, wherein a coupling hole is formed in the one surface of the module case, and the coupler is inserted into the coupling hole.

9. The battery module according to claim 6, wherein a plurality of couplers are provided and coupled to the module case.

10. The battery module according to claim 9, wherein a plurality of sealing holes in communication with the through-hole is formed in the sealing pad along one direction, and the plurality of couplers are disposed between the plurality of sealing holes.

11. The battery module according to claim 1, wherein the sealing pad is configured to be compressible and recoverable, and the coupler is configured to couple the sealing pad to the module case in a compressed state.

12. The battery module according to claim 1, wherein the sealing pad includes a thermally expandable material.

13. The battery module according to claim 12, wherein the thermally expandable material is provided in a coated form on a surface that is in contact with the module case.

14. The battery module according to claim 1, wherein the cooling plate includes:
a fluid discharge hole communicating with the flow path and disposed to face the through-hole, and
a seal coupled to the cooling plate to block the fluid discharge hole and configured to be ruptured when the thermal event occurs.

15. A battery pack comprising at least one battery module according to claim 1.

16. A battery pack comprising:
a pack case;
a module case accommodated in the pack case, the module case being configured to accommodate a plurality of battery cells therein and having a through-hole formed in one surface thereof;
a cooling plate coupled to the one surface of the module case and having a flow path in which a coolant is accommodated, the cooling plate being configured such that the coolant is discharged through the through-hole when a thermal event of the battery cells occurs;
a sealing pad disposed between the module case and the cooling plate and configured to seal at least a portion of a space between the module case and the cooling plate; and
a coupler configured to couple the sealing pad and the module case such that the sealing pad comes into close contact with the module case.

17. A vehicle comprising at least one battery pack according to claim 15.
